(19) United States
(12) Patent Application Publication
(10) Pub. No.: US 2016/0098574 A1
(43) Pub. Date: Apr. 7, 2016

(54) SYSTEMS AND METHODS TO MANAGE FILE ACCESS

(71) Applicant: Cynny Spa, Firenze (IT)

(72) Inventor: Stefano Bargagni, Constanta (RO)

(21) Appl. No.: 14/691,335

(22) Filed: Apr. 20, 2015

Related U.S. Application Data
(60) Provisional application No. 62/060,999, filed on Oct. 7, 2014.

(51) Int. Cl. G06F 21/62; G06F 17/30

(52) U.S. Cl. CPC G06F 21/6218; G06F 17/30327

(57) ABSTRACT

A file system configured to use tags to control operations on files stored in the system. Each tag is usable to tag one or more of the files stored in the system and/or one or more other tags in the system. Each tag identifies one or more privileges for a user of the tag to operate on tagged files. Tags are sharable in the system for use by various users, which may create tags, modify tags, share tags, apply tags to selected tags and/or files in the system, and follow chains of tagging to access tagged files. The chains of tagging may include loops/circles in a graph of tags in the system.

### RELATED APPLICATIONS

This application claims priority to U.S. Provisional Application Ser. No. 62/060,999, filed Oct. 7, 2014, entitled “SYSTEMS AND METHODS TO MANAGE FILE ACCESS,” by Stefano Bargagni, the entire contents of which application is incorporated by reference as if fully set forth herein.

### BACKGROUND

Known tagged file systems are typically implemented by adding a tag-id directly in a document descriptor. Tagged file systems are generally represented graphically as a tree.

In a typical file system, a tree hierarchy of documents is typically implemented via folders (or directories), where a folder may contain documents or other folders. A parent folder may contain one or more child folders, but a child folder cannot be constructed to contain its parent. Although a cycle/loop may be introduced in the system via a special arrangement such as a symbolic link to a parent folder, the arrangement that utilizes special elements that are different from folders and documents in the system can be identified to remove the cycle/loop. Thus, such a file system essentially has a tree representation of hierarchy.

### BRIEF DESCRIPTION OF THE DRAWINGS

The embodiments are illustrated by way of example and not limitation in the figures of the accompanying drawings in which like references indicate similar elements.

FIG. 1 shows a tag system according to one embodiment.

FIG. 2 shows a method to access files according to one embodiment.

FIG. 3 illustrates an example of a tag graph according to one embodiment.

FIG. 4 shows the sharing of tags according to one embodiment.

FIG. 5 shows a tag structure according to one embodiment.

FIGS. 6-9 illustrate document sharing via a social network according to one embodiment.

FIG. 10 illustrates a data processing system according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

In one embodiment, a computer data storage system is configured to store a set of users. The system is configured to allow users to share information stored in the system.

For example, after a user is authenticated for access (e.g., via Social Network OAuth APIs), the user may upload a catalog of files. The user is allowed to modify the files with versioning of the files, and/or share the files other users. The user is allowed to organize the view of a sub-set of his or her catalog of files and let it be viewed by a list of users (or also by all the world) as a webpage or a video, or any other way to present it, accessible, for example, via http protocol (or any other communications protocol).

In one embodiment, the system is configured to allow a user to organize the files/documents by assigning one or more tags to the files/documents. A document can be tagged by multiple tags; and a tag itself can also be tagged by one or more other tags. The number of documents a tag can tag/contain is not limited in one embodiment. In other embodiments, a defined limit can be placed on this number.

In one embodiment, the tagging of files in the system is not limited to a tree topology. The user may construct tagged relations in a form of graph that contains one or more cycles or loops.

In one embodiment, the users in the system are connected via a social network or a personal account; and users are allowed to share documents and apply tags on shared documents. Tags can be applied to documents by both: (a) the users who are the owners of the respective documents; and (b) the users with whom the owners have shared the respective documents. Similarly, users are allowed to share tags and apply tags on shared tags. Tags can be applied to shared tags by both: (a) the users who are the owners of the respective shared tags; and (b) the users with whom the owners have shared the respective shared tags. In one embodiment, the graph of tags is visible to users who share that part of the graph.

In one embodiment, the tag arrangement described herein gives the tag graph a robust description power, which enriches the experience of users in terms of the power of the number of sharing times and subsets of a graph shared to other different users, as further discussed below.

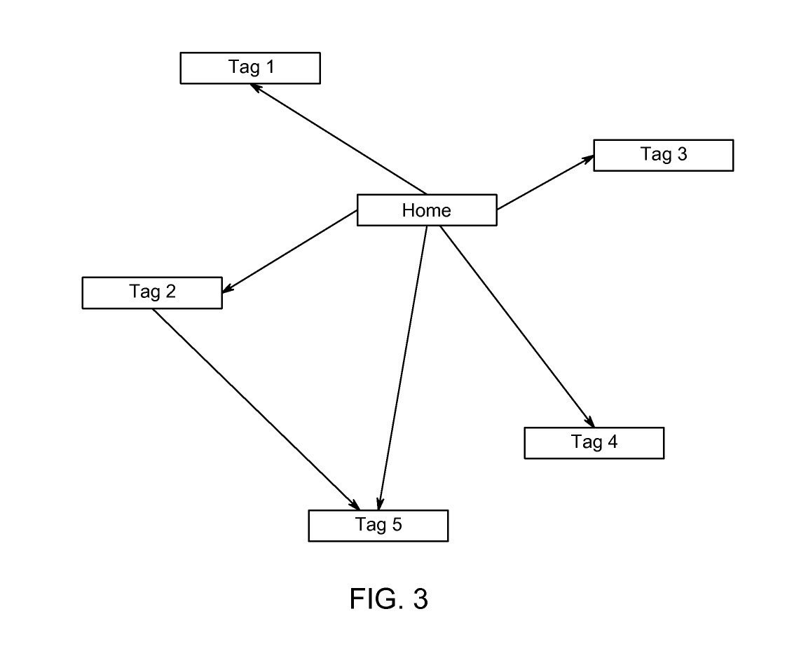

In one embodiment, the files in the system are tagged at least once. There is no limit to the number of tags a file can have. Further, a tag itself can be tagged by one or more other tags. This construction allows a file system that can be represented as a tag graph, as illustrated in FIG. 3.

In FIG. 3, a home tag of a user is applied to (e.g., tagged by) tag1, tag2, tag3, tag4, tag5 (as indicated by the arrows); and tag2 is applied to tag5.

In one embodiment, the tag graph is social based, in which a user can let any other user link (e.g., tag) his/her tags or, more generally, be a part of his/her tag graph (e.g., a tag sub-graph).

In one embodiment, a home tag is used to represent a user. It is a root of the tags owned by the user. Tags created by the user are descents of the home tag of the user.

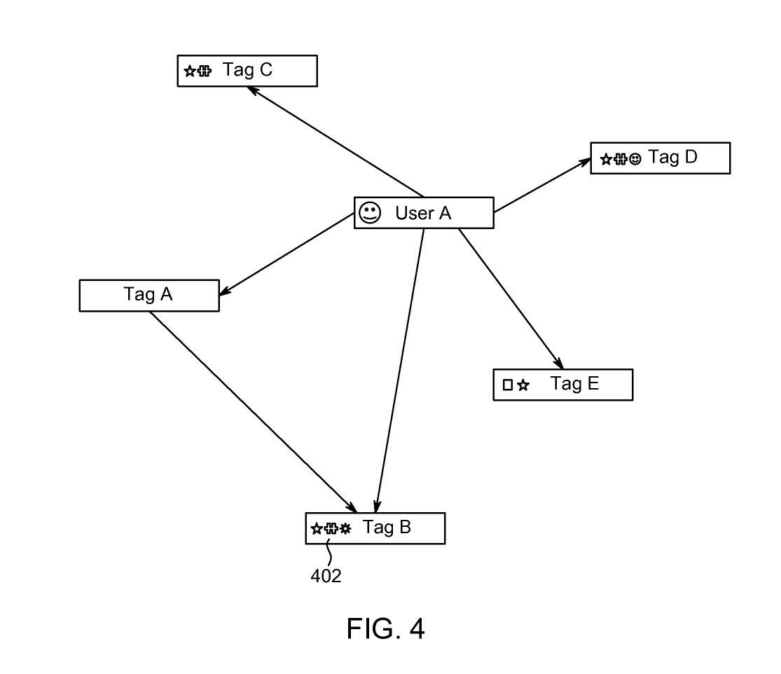

In FIG. 4, avatar pictures (illustrated as small images within a given tag) are shown in the representation of the tags (corresponding to tag1 to tag5 of FIG. 3) to indicate the identity of other users with whom the user has shared the tags. For example, Tag B has three avatar pictures 402 to indicate that Tag B is shared with the three users represented by the avatar pictures 402.

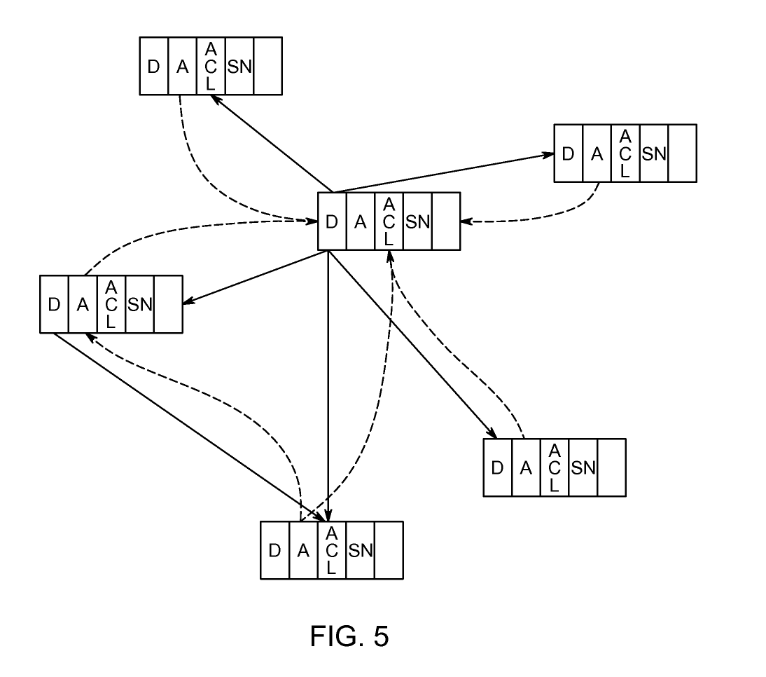

Tag graphs can be implemented using any graph-representing techniques known in the art. For example, information nodes containing pointers to descendants and pointers to ancestors may be used to implement the tag graph in a way as illustrated in FIG. 5.

In FIG. 5, the illustrated pointer structure corresponds to the tag graph illustrated in FIG. 3. In FIG. 5, data field (D) contains pointers to descendants, and data field (A) contains pointers to ancestors. Using this representation of a tag graph, each graph node can be reached by crawling the graph using various known algorithms (e.g., Dijkstra).

In one embodiment, each tag includes a field (ACL) for specifying access permission and a field (SN) for specifying information related to a social network (SN). By using the ACL and SN fields illustrated in FIG. 5, a tag can identify: the user who owns the tag; a set of users who are permitted to access the tag for reading; and a set of users who are permitted to access the tag for modifying (e.g., adding file and sharing it).

This approach for a file system allows users to interact with simple rules. As more users interact with the system, the tag graph grows and becomes more complicated. Information shared in such a way is improved and enriched.

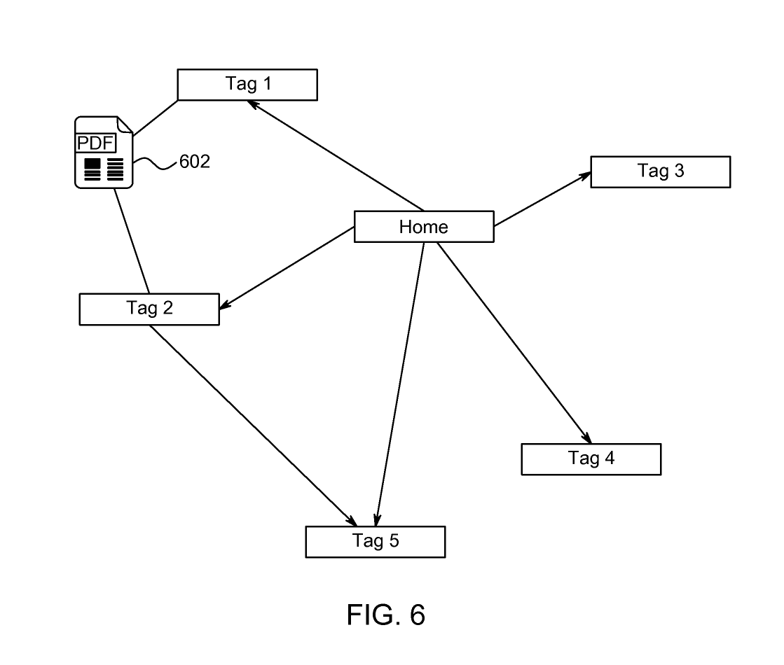

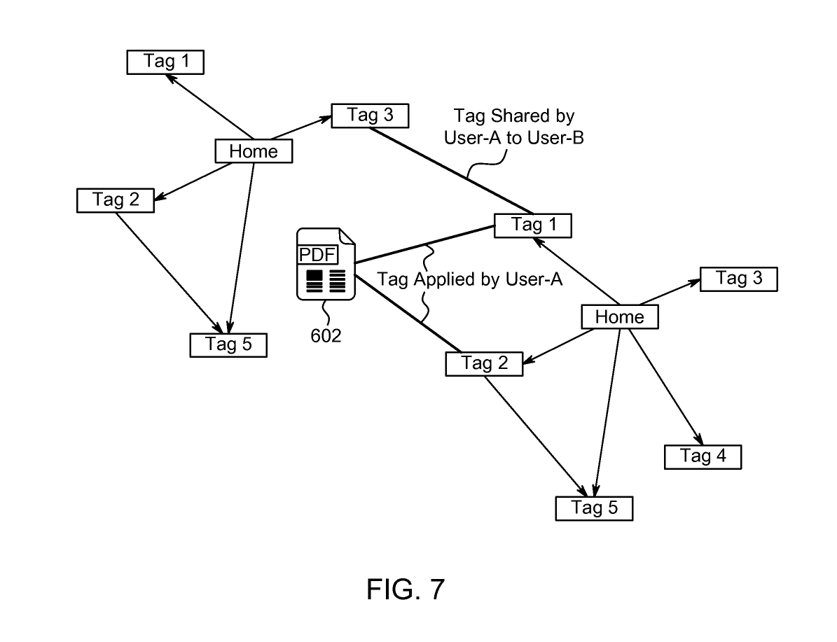

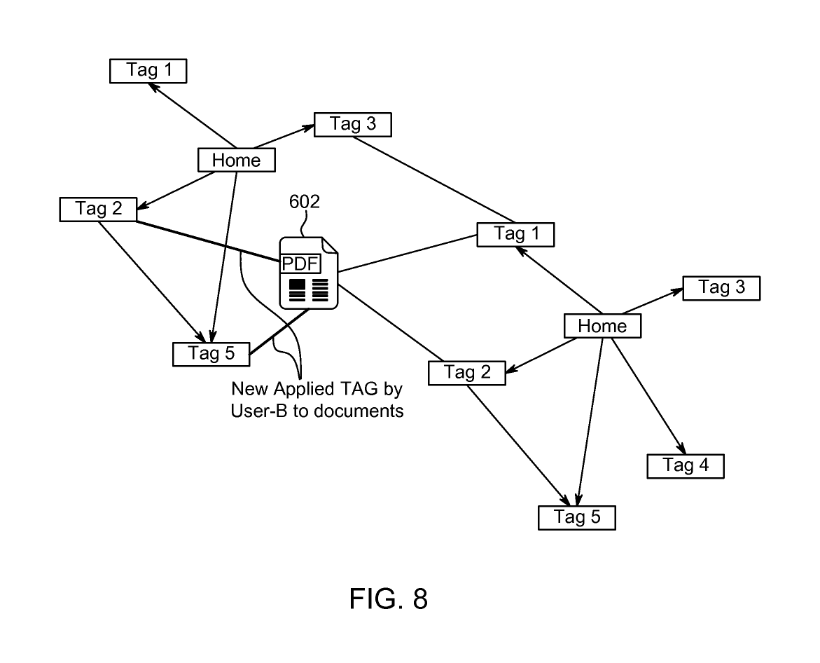

FIGS. 6-9 illustrate document sharing via a social network according to one embodiment. For example, assume userA has applied TAG1 and TAG2 to a PDF document 602, as illustrated in FIG. 6. Then, userA shares TAG1 with a userB. This sharing allows userB to apply one of userB's tags to TAG1 of userA, as illustrated in FIGS. 7 and 8.

Once a document, a tag, or a subset of tags of a user has been shared in the social network, it can be modified in content and tagged by other users (e.g., other users in the social network). For example, in FIG. 8, since userB is given access to the document, userB may apply some tags directly to the document or to any tag (e.g., a tag shared by userA).

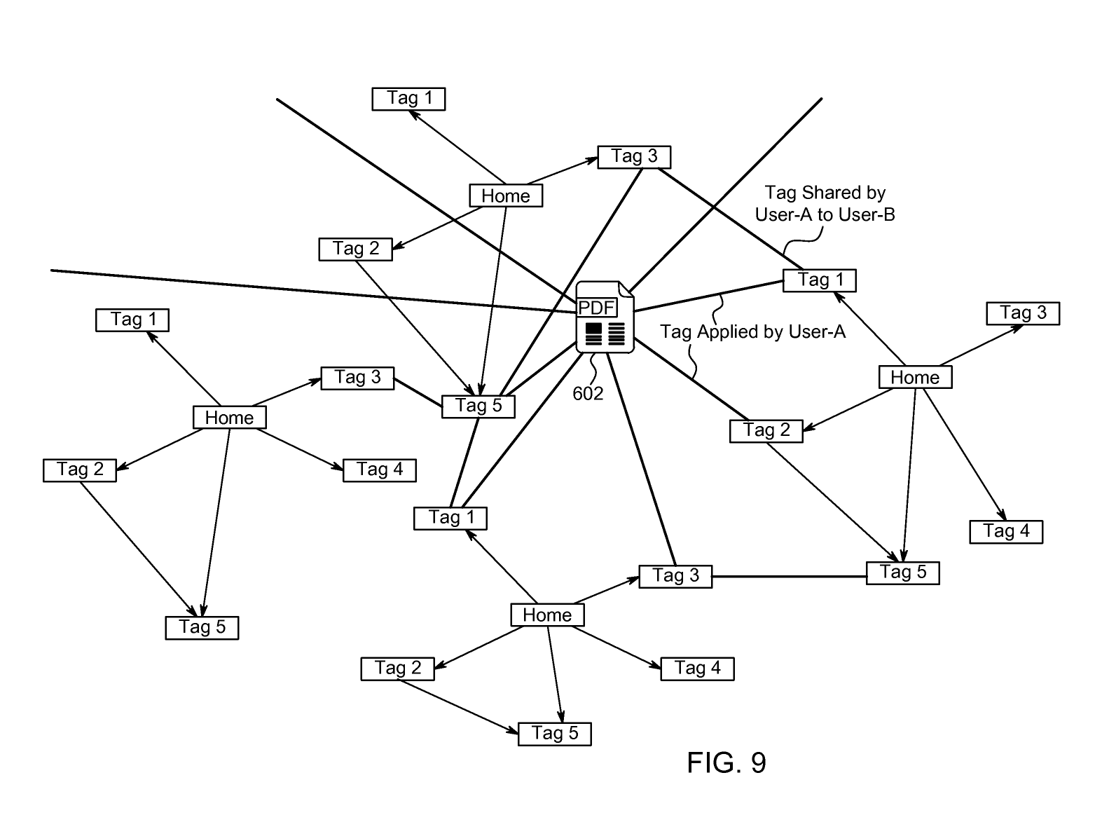

In one embodiment, there are no limits to the level of complexity that the tag graph can reach via user interactions, as illustrated in FIG. 9. For example, document 602 can be changed by a user, and the document can be tagged and shared again. By this process, a description of document 602 can be enriched by the application of an unlimited number of tags (e.g., the application of thousands or millions of tags).

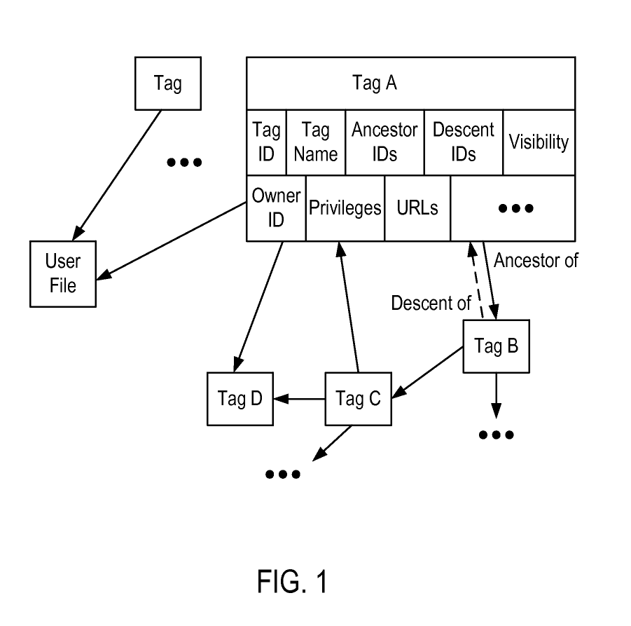

FIG. 1 shows a way to apply tags to a user file according to one embodiment. In FIG. 1, one or more tags, such as tag A, can be applied to a user file. Also, one or more tags can be applied to a tag, such as Tag A being applied to Tag B and Tag D, and Tag C being applied to Tag A and Tag D.

A typical tag, such as Tag A, may include a plurality of data fields, such as Tag ID, Tag Name, Ancestor IDs, Descent IDs, Owner ID, Privileges, URLs, Visibility, etc.

The Tag ID field uniquely identifies the tag among the tags created in the system. The Tag Name field is a text label used for presentation of the tag to a user.

The Ancestor IDs field includes the list of tag IDs of tags that have been applied to the tag. For example, in FIG. 1, Tag A is applied to Tag B; and thus Tag A is an ancestor of Tag B; the list of Ancestor IDs in Tag B includes the Tag ID of Tag A.

The Descent IDs field includes the list of tag IDs of tags to which the tag (e.g., Tag A) is applied. For example, in FIG. 1, Tag A is applied to Tag B; and thus Tag B is a descent of Tag A; the list of descent IDs in Tag A includes the Tag ID of Tag B. In some embodiments, the Descent IDs field of the tag may also include the IDs of the files to which the tag is applied.

The Owner ID field uniquely identifies a user that creates the tag.

The URLs field identifies one or more (e.g., up to 10) URL addresses that can be visited to view information (e.g., content or other data) related to the tag. Each of the URLs points to, for example, a web page that contains: documents (e.g., files to which the tag is applied), links (e.g., URL) to other pages (e.g., tags to which the tag is applied). In one embodiment, a link is included or presented in the page, if and only if a tag visibility (e.g., in the Visibility field) is set to PUBLIC.

The Visibility field indicates whether or not URLs are active. In one embodiment, the URLs are active only when the Visibility of the tag is set to PUBLIC.

The Privileges field identifies the set of rights provided by the owner of the tag to the users of the tag. Examples of privileges include read-only, read and write, delete, share read-only, share with modify, etc. For example, a “read-only” privilege specified in the tag indicates that a user of the tag may only view the tag and the objects (e.g., files or other tags) to which the tag is applied. However, the user is not allowed to share or modify the objects to which the tag is applied.

As another example, a “write” privilege specified in the tag indicates that a user of the tag may modify the tag and the objects (e.g., files or other tags) to which the tag is applied. The user is not allowed to share the tag and the objects with others to which the tag is applied. This power is given by a “share write” permission.

In another example, a public sharing level specified in the privilege may allow everyone on the network to access the tag via its public URL (or by any other method or protocol) in a read-only mode.

A user may create a tag A, apply the tag A to another tag D or to a document or user file, dis-apply the tag to an object, delete the tag, or share the tag (consequently a sub-graph of tags) with friends or other users to provide permissions/privileges specified in the tag, or change permissions/privileges given in the tag.

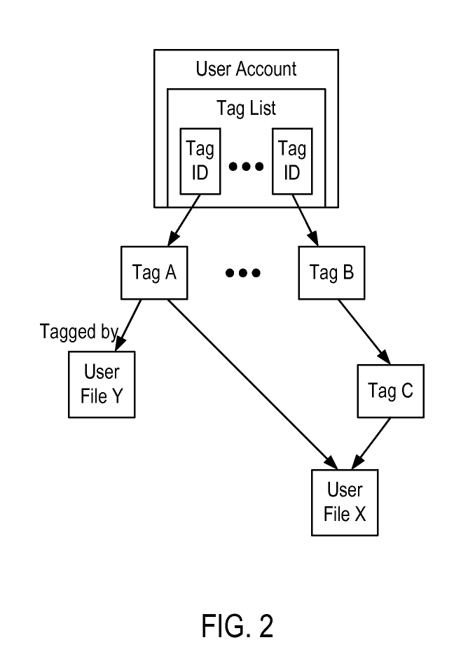

In FIG. 2, a user account includes a tag list that identifies the tags created by the user of the account, or shared by other users with the user of the account. The tag list includes tag IDs that uniquely identify the respective tags, such as Tag A . . . Tag B in FIG. 2.

In one embodiment, the user account in FIG. 2 is represented by a home tag (e.g., “HOME”) as illustrated in FIG. 3, in which the home tag is created automatically for the user and applied to the tags created by the user. In one embodiment, the home tag of the user is the only “root” of the graph of tags of the user; and the user starts to navigate the graph from the root.

In one embodiment, the system is also configured to include a “super-root” that tags all users in the system, in which each user is presented by a home tag that tags the personal tags of the user.

Further, in one embodiment, the system may generate “meta-tags” that are (for instance) auto-generated “tags of tags”, global or personal. For example, a meta-tag may be generated to represent all of the users in Florence; and another meta-tag can generated to represent the summer photos of the users (e.g., in the year 2014, 2015, etc.)

In one embodiment, the system is configured to index the tags and allow users to look up/search, starting from a root (e.g., the ‘root’ of the user base) and below. The system is also configured to provide a directory for the tags to let search engines (e.g., Google) index the tags and their documents. The control of this is given to the users by permissions on their respective tags.

In the example of FIG. 2, Tag A is applied to the User File Y and User File X; Tag C is applied to User File X; and Tag B is applied to Tag C. The user of the account may start to access the objects in the system from the tags identified in the tag list for the user account and follow the graph of tags to visit the ancestors of the tags (or start with the home tag of the user, as discussed above).

For example, the user of the account may select the tag B to access the tag C to which tag B is applied and then select user file X to which the tag C is applied in order to access user file X. When the user accesses the user file X via the tag B, the permissions/privileges of the user in accessing the user file X are determined by the privileges specified in tag B.

In the example of FIG. 2, the user can also access the same user file X via tag A, since the tag A is applied directly to the user file X in FIG. 2. When the user accesses the user file X by traversing the tag graph to reach the user file staring from tag A, the permissions/privileges of the user in accessing the user file X are determined by the privileges specified in tag A.

For example, the owner of the user file X may create tags A and C and apply them to user file X, where the tag A is also applied to user file Y. The owner of the user file X shares the tag A with the user of the user account, shares the tag C with a friend who in turn applies tag B to tag C and shares the tag B with the user of the user account illustrated in FIG. 2. Thus, the user of the user account illustrated in FIG. 2 has multiple ways to access the user file X, each of which ways may provide a different set of privileges with respect to the user file X.

For example, userA shares TAG-1 with userB in read-only mode. TAG-1 is applied to and thus contains file-x. UserA also shares TAG-2 with userB in write mode, wherein TAG-2 is also applied and thus contains file-x. UserB is allowed to modify file-x by reaching it via TAG-2, but not by reaching it via TAG-1.

In one embodiment, the visibility of a tag can be set to public (live tag) or private (“no expose” to WWW, or other applications/protocols). When the tag is public, it is shared with any user who can access the tag via the URLs of the tag.

In one embodiment, a tag can be set as public with an expiration date and time, after which the tag becomes private. It could also become private after a defined number of N views, or by other criteria. In one embodiment, a user may specify an expiration criterion (example given time and/or date); and the system is configured to put the tag in a private mode when the expiration criterion is satisfied.

In one embodiment, when a tag is private, it can be accessed only by users to whom the tag is explicitly shared by other users that have the privilege to share the tag.

In one embodiment, the system is configured to read a tag graph by level. When a tag is selected, the system reads and presents the tags and documents to which the selected tag is applied directly.

In one embodiment, the system allows the user to select multiple tags and apply the selected tags to a document, such as a document to be uploaded, or a document that has already been uploaded to the system.

In one embodiment, a web interface and/or a mobile application interface is provided to present the graph of tags accessible to the user, starting from the home tag of the user. The interface allows the user to navigate the graph of tags accessible to the user to visit tags and/or documents to which the tags are applied.

In one embodiment, the system is configured to periodically check the graph for consistency of links among the tags. When the system detects file system inconsistencies, they are solved at the file-system level, such as by checking object status when it is requested or by a sample-based background check.

### Data Processing Implementation

The systems and methods disclosed above are implemented in a computer apparatus in the form of a data processing system.

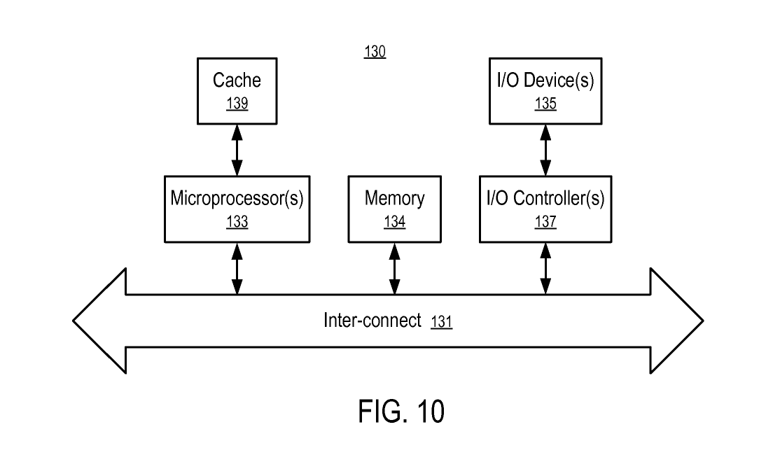

FIG. 10 illustrates a data processing system according to one embodiment. While FIG. 10 illustrates various components of a computer system, it is not intended to represent any particular architecture or manner of interconnecting the components. One embodiment may use other systems that have fewer or more components than those shown in FIG. 10.

In FIG. 10, the data processing system (130) includes an inter-connect (131) (e.g., bus and system core logic), which interconnects one or more microprocessors (133) and memory (134). The microprocessor (133) is coupled to cache memory (139) in the example of FIG. 10.

In one embodiment, the inter-connect (131) interconnects the microprocessor(s) (133) and the memory (134) together and also interconnects them to input/output (I/O) device(s) (135) via I/O controller(s) (137). I/O devices (135) may include a display device and/or peripheral devices, such as mice, keyboards, modems, network interfaces, printers, scanners, video cameras and other devices known in the art. In one embodiment, when the data processing system is a server system, some of the I/O devices (135), such as touch screens, printers, scanners, mice, and/or keyboards, are optional.

In one embodiment, the inter-connect (131) includes one or more buses connected to one another through various bridges, controllers and/or adapters. In one embodiment the I/O controllers (137) include a USB (Universal Serial Bus) adapter for controlling USB peripherals, and/or an IEEE-1394 bus adapter for controlling IEEE-1394 peripherals.

In one embodiment, the memory (134) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A system, comprising:
at least one processor; and
memory storing instructions configured to instruct the at least one processor to:
store a set of files and a plurality of tags, the tags including a first tag, a second tag, and a third tag;
apply the first tag to a first file of the set of files, wherein user access to the first file via the first tag is determined by a first privilege specified in the first tag;
apply the second tag to the third tag;
apply the third tag to the first file; and
provide user access to the first file via the second tag, wherein the user access is determined by a second privilege specified in the second tag.

2. The system of claim 1, wherein the first privilege and second privilege are different.

3. The system of claim 2, wherein the first privilege is a read-only privilege, and the second privilege is a write privilege.

4. The system of claim 1, wherein the second tag can be accessed only by users to whom the second tag is shared by an owner of the second tag.

5. The system of claim 1, further comprising a user interface to present a graph of tags to a first user, including presenting a home tag of the first user, the user interface allowing the first user to navigate the graph of tags to visit documents to which tags in the graph are applied.

6. The system of claim 1, wherein the instructions are further configured to instruct the at least one processor to store a tag list for a first user, the tag list comprising a unique tag identifier for each of the first and second tags.

7. The system of claim 1, wherein each of the plurality of tags comprises a tag identifier field, a descent identifiers field, and a privileges field, wherein the descent identifiers field comprises a list of tag identifiers to which the tag is applied, and the privileges field identifies rights provided by an owner of the tag to other users.

8. The system of claim 1, wherein each of the plurality of tags comprises a field that identifies at least one URL address that can be visited by a user to view information related to the tag.

9. A non-transitory computer storage medium storing computer-readable instructions, which when executed, cause a data processing system to:
store, by the system, a set of files and a plurality of tags, the tags including a first tag, a second tag, and a third tag;
apply the first tag to a first file of the set of files, wherein user access to the first file via the first tag is determined by a first privilege specified in the first tag;
apply the second tag to the third tag;
apply the third tag to the first file; and
provide user access to the first file via the second tag, wherein the user access is determined by a second privilege specified in the second tag.

10. The non-transitory computer storage medium of claim 9, wherein the first privilege and second privilege are different.

11. The non-transitory computer storage medium of claim 10, wherein the first privilege is a read-only privilege, and the second privilege is a write privilege.

12. The non-transitory computer storage medium of claim 9, wherein the second tag can be accessed only by users to whom the second tag is shared.

13. The non-transitory computer storage medium of claim 9, wherein the instructions further cause the data processing system to present a graph of tags to a first user on a user interface, the user interface allowing the first user to navigate the graph of tags to access documents to which tags in the graph are applied.

14. The non-transitory computer storage medium of claim 9, wherein the instructions further cause the data processing system to store a tag list for a first user, the tag list comprising a unique tag identifier for each of the first and second tags.

15. The non-transitory computer storage medium of claim 14, wherein each of the plurality of tags comprises a descent identifiers field, wherein the descent identifiers field comprises a list of tag identifiers to which the tag is applied.

16. A method, comprising:
storing, in a computing apparatus, a set of files and a plurality of tags, each respective tag:
identifying one or more privileges,
usable to tag one or more of the files to provide the privileges to a user of the respective tag,
owned by a respective user of the computing apparatus, and
sharable for use by one or more users; and
presenting, by the computing apparatus, the plurality of tags to users of respective tags to access tags tagged by the respective tags and files tagged by the respective tags in accordance with privileges identified in the plurality of tags.

17. The method of claim 16, wherein the plurality of tags includes a first tag that tags a second tag which tags the first tag directly.

18. The method of claim 16, wherein the plurality of tags includes a first tag that tags a second tag which tags the first tag indirectly via one or more third tags.

19. The method of claim 16, further comprising:
presenting a subset of the plurality of tags to a third user;
receiving input from the third user to select a starting tag from the subset of tags;
receiving input from the third user to reach an ending tag via an access request following a chain of tagging starting from the starting tag;
receiving input from the third user to access a file tagged by the ending tag; and
providing the third user access to operate on the file based on privileges specified in the starting tag.

20. The method of claim 16, wherein each respective tag is further usable to tag a subset of the plurality of tags to identify at least one privilege of a user of a tag in the subset.
